(19) United States
(12) Patent Application Publication
(10) Pub. No.: US 2024/0270074 A1
(43) Pub. Date: Aug. 15, 2024

(54) DISPLAY PANEL FOR A VEHICLE

(71) Applicant: CLARION CORPORATION OF AMERICA, Auburn Hills, MI (US)

(72) Inventors: Young Ghi HONG, Rochester Hills, MI (US); Mark MATHEWS, Lombard, IL (US)

(21) Appl. No.: 18/109,648

(22) Filed: Feb. 14, 2023

(51) Int. Cl. B60K 37/02; B60K 37/06

(52) U.S. Cl. CPC B60K 35/60; B60K 35/10; B60K 35/22; B60K 2360/1434; B60K 2360/29

(57) ABSTRACT

A display panel for a vehicle includes a holographic optical element configured to create a real hologram image. A sensor is configured to detect a position of a user's finger with respect to the real hologram image. A display screen is configured to emit light through the holographic optical element. The light from the display screen creates the real hologram image with the holographic optical element being located between the display screen and the real hologram image.

### TECHNICAL FIELD

The present disclosure is related generally to vehicle displays, and more particularly, to display devices having holographic capabilities.

### BACKGROUND

For human machine interfaces (HMIs) in display systems, usually tangible knobs, push-buttons, and toggle switches are used, which can stick out of the display screen. Additionally, they also have the potential to cut off the image on the display depending on the location of the knob and the viewer's eye. Furthermore, if one incorporates a separate display onto the knob itself, for example, the solution can be difficult to configure and expensive. Holographic switches can remedy these potential deficiencies. While some holographic switches do exist, such as those shown in JP 2022039582A to Dai Nippon Printing, the display assemblies can be bulky and more costly to assemble, particularly within the more confined spaces in a vehicle. These systems typically use reflective style holography, which can require a more complicated and costly arrangement.

### SUMMARY

An illustrative display panel for a vehicle includes a holographic optical element configured to create a real hologram image. A sensor is configured to detect a position of a user's finger with respect to the real hologram image. A display screen is configured to emit light through the holographic optical element. The light from the display screen creates the real hologram image with the holographic optical element being located between the display screen and the real hologram image.

In various embodiments, a change of the position of the user's finger through the real hologram image in an X-direction, in a Y-direction, in a Z-direction, or in two or more of the X-direction, the Y-direction, and the Z-direction results in a proportional adjustment to a vehicle function.

In various embodiments, the real hologram image has a circular shape and an arced shape path of the user's finger in the X-direction and in the Y-direction results in the proportional adjustment to the vehicle function.

In various embodiments, the circular shape is a ring having an opening in a middle of the circular shape where at least a portion of an image on the display screen is visible.

In various embodiments, the real hologram image is a bar shape and the change of position of the user's finger in the X-direction or in the Y-direction results in the proportional adjustment.

In various embodiments, the vehicle function is a control of an HVAC system or a control of an infotainment system.

In various embodiments, an image on the display screen is configured to change to account for the proportional adjustment to the vehicle function.

In various embodiments, an image on the display screen is configured to change based on input from the sensor.

In various embodiments, the sensor is a light-transmissive hover touch capacitive sensor.

In various embodiments, the real holographic image is a transmission hologram.

In various embodiments, the holographic optical element is a computer generated holographic layer having a surface relief pattern.

In various embodiments, the holographic optical element is located on a cover lens adjacent an interior cabin of the vehicle.

In various embodiments, the holographic optical element is sealed with an optically clear adhesive layer between the display screen and a cover lens.

In various embodiments, there are a plurality of holographic optical elements, wherein each holographic optical element is configured to create a different segment of the real holographic image.

In various embodiments, there are a plurality of holographic optical elements, wherein a first holographic element of the plurality of holographic elements creates the real holographic image and a second holographic element of the plurality of holographic elements creates a separate, second real holographic image.

It is contemplated that any number of the individual features of the above-described embodiments and of any other embodiments depicted in the drawings or description below can be combined in any combination to define an invention, except where features are incompatible.

### BRIEF DESCRIPTION OF THE DRAWINGS

Illustrative embodiments will hereinafter be described in conjunction with the following figures, wherein like numerals denote like elements, and wherein:

FIG. 1 is a perspective view of the interior of a vehicle passenger cabin showing one example display panel;

FIG. 1A shown an enlarged portion of the display panel of FIG. 1;

FIG. 2 is a cross-sectional view of a portion of the display panel of FIG. 1;

FIG. 3. is another cross-sectional view of a portion of the display panel of FIG. 1; and

FIG. 4 is an enlarged, schematic, perspective view of a holographic optical element from the display panel of FIG. 1.

### DESCRIPTION OF ILLUSTRATIVE EMBODIMENTS

Described herein is a display panel for a vehicle with holographic capabilities. Unlike more typical reflective-type assemblies, which require complex arrangements and supplemental light sources, the display panel herein has a more simplified structure with streamlined components. Additionally, a sensor is provided to detect a change of position of the user's finger through the hologram image, which can then be used to modify or otherwise control various functionalities within the vehicle. This can help minimize touch-related contamination in the vehicle cabin, since direct touch of the panel is not needed, and can help minimize the number of components physically sticking out from the panel into the cabin.

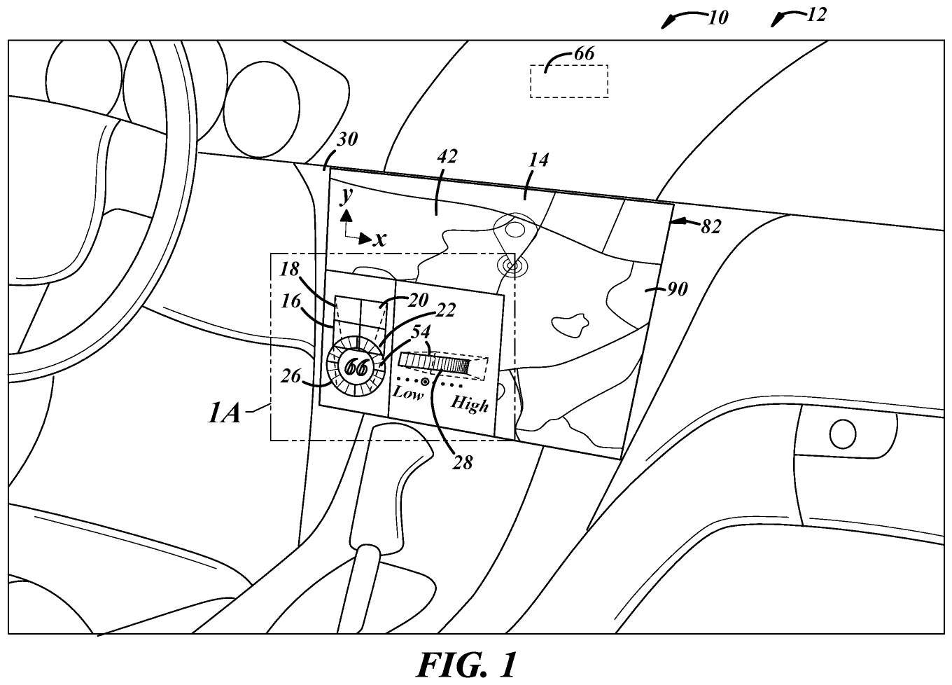

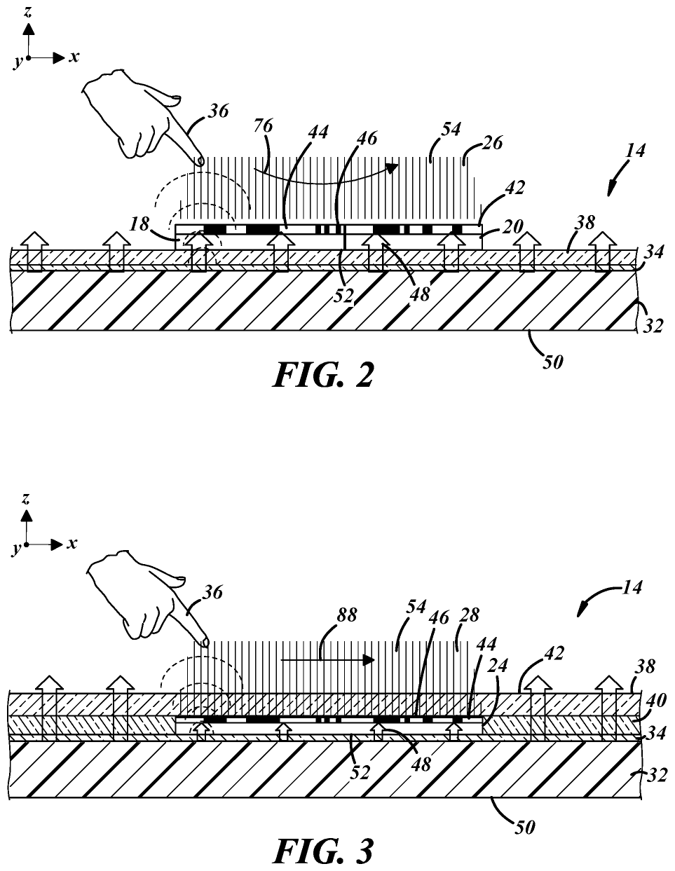

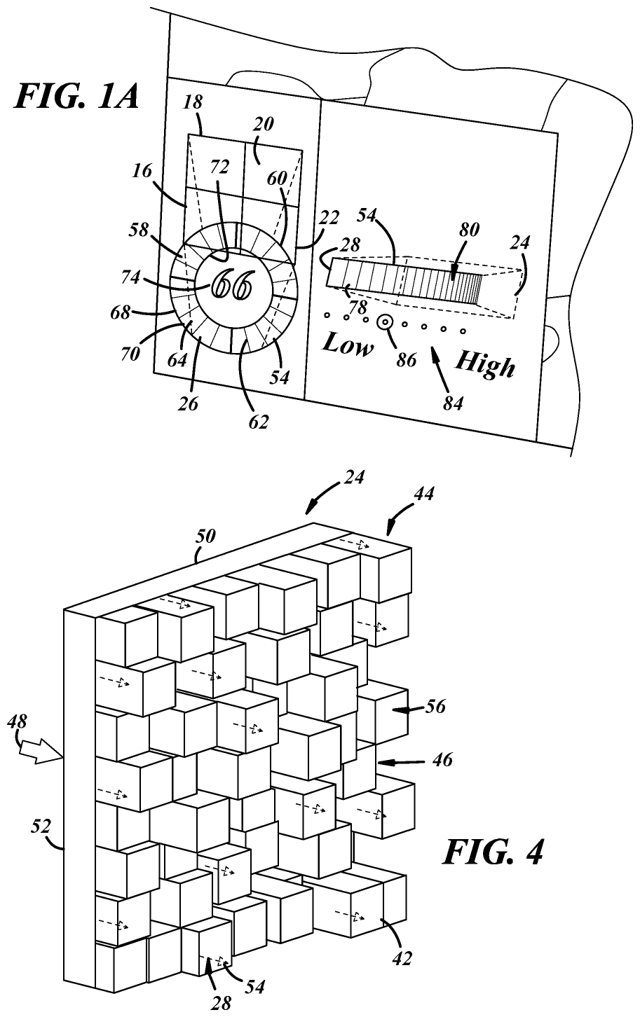

FIG. 1 is a perspective view of an interior of a passenger cabin 10 of a vehicle 12 having a display panel 14. FIG. 1A also shown an enlarged view of a portion of the display panel 14. In the example embodiment shown in FIG. 1 and FIG. 1A, the display panel 14 includes holographic optical elements 16, 18, 20, 22, 24 that are used to create real hologram images 26, 28. For ease of explanation, two embodiments of the hologram images 26, 28 and the corresponding structure used to accomplish each are shown in FIG. 1 and in FIG. 1A, but it is more likely that only one structure type will be used per display panel 14 (although it is certainly possible to have multiple types of holographic images in one display panel, it may be more economical for the display panel to have only a single underlying structure arrangement to produce the holographic images 26, 28). FIG. 2 schematically illustrates a structural arrangement where the holographic optical elements 18, 20 are arranged closer to the passenger cabin 10, whereas FIG. 3 schematically illustrates a structural arrangement where the holographic optical element 24 is shielded from the passenger cabin 10.

As shown more particularly in the schematic, cross-sectional representations of FIGS. 2 and 3, the real hologram images 26, 28 extend from the holographic optical elements 16, 18, 20, 22, 24 into the interior cabin 10. As detailed further below, the real hologram images 26, 28 are advantageously used as switches to control various functionalities relating to the vehicle 12. Additionally, the structure of the display panel 14 is simplified to omit the need for an additional light source or complex projection-style arrangement, which can be easier to manufacture and decrease costs of the assembly. The display panel 14 in the illustrated embodiment is part of the main instrument panel 30. However, other interior panels for vehicle components may be integrated with holographic switches and the illumination schemes described herein, such as one or more display panels for the steering wheel, door panels, center consoles, or rear seating areas, to cite a few examples.

FIG. 2 is a schematic, cross-sectional view of a portion of the display panel 14, showing the holographic optical elements 18, 20 and the real hologram image 26, and FIG. 3 is a schematic, cross-sectional view of another portion of the display panel 14, showing the holographic element 24 and the real hologram image 28. In the embodiments, the panel 14 includes a display screen 32 and a sensor 34 configured to detect a position of a user's finger 36 with respect to the real hologram images 26, 28. Other features such as a cover lens 38 and an optically clear adhesive or bonding layer 40 (see e.g., the embodiment illustrated in FIG. 3) can be included between two or more of the various layers or components of the display panel 14. Further, other layers may be included in addition to those particularly described, such as one or more protective outer layers on the cabin facing side 42, conductive electronic layers, or other functional and/or aesthetic layers.

The holographic optical elements 16, 18, 20, 22, 24 are used to create the real hologram images 26, 28. It should be understood that teachings relating to one holographic optical element are also applicable to any of the other holographic elements, unless there is an incompatibility of features. Similarly, teachings relating to the hologram image 26 are applicable to the hologram image 28 and vice versa. The holographic optical element 24 is also shown in an enlarged (not necessarily to scale), perspective view in FIG. 4. In the illustrated embodiments, the holographic optical elements 16, 18, 20, 22, 24 are each a computer generated holographic layer 44 having a surface relief pattern 46. The surface relief pattern 46 is structured to selectively diffract light 48 emitted from the display screen 32. As shown in FIG. 4, the surface relief pattern 46 is advantageously located on the cabin facing side 42. On the exterior facing side 50, opposite the cabin facing side 42, there is a continuously planar surface 52. In some embodiments, it may be possible to have the surface relief pattern 46 on the exterior facing side 50 instead, or to include a surface relief pattern on both sides 42, 50. Having the surface relief pattern 46 closer to the cabin 10 as illustrated, however, can potentially improve the quality of the real hologram image 28. As detailed below, while having the computer generated holographic layer 44 for the holographic optical element 24 can be beneficial, there are other methodologies for manufacturing each holographic optical element and accordingly, other types of holographic optical elements are possible. For example, the holographic optical elements may include one or more holographic plates or films, with the pixel dispersion characteristics formed by a coherent laser beam or some other holographic implementation processing.

The holographic optical elements 16, 18, 20, 22, 24 are advantageously structured to create a transmission hologram 54 for the real hologram images 26, 28. In such an embodiment, light 48 emitted from the display screen 32 creates the real hologram 26, 28. This helps minimize complexity of the display panel 14, since a separate light source is not needed for selectively illuminating the holographic optical elements 16, 18, 20, 22, 24. This arrangement is different than transmission holograms that are virtual images or projection/reflective style holograms. In some embodiments, there may be an additional lens, filter, etc. that could help collimate or otherwise focus the light 48 from the display screen 32.

As shown schematically in FIG. 4 and not necessarily to scale, the surface relief pattern 46 of the holographic optical element 24 helps to selectively diffract the light 48 from the backlighting display screen 32. The surface relief pattern 46 has a plurality of pixel columns 56 that vary in height depending on the desired look for the real hologram image 28. In this embodiment, the surface relief pattern 46 is formed by computer generated holography such that the holographic optical element 24 is a computer generated hologram 44, but as described, it is possible to have alternate configurations and methods of manufacture for the holographic optical elements.

Returning to FIGS. 1 and 2, the holographic optical elements 16, 18, 20, 22 are located directly on the cabin facing side 42 of the display panel 14. In this embodiment, the sensor 34 and the cover lens 38 are located between the holographic optical elements 16, 18, 20, 22 and the display screen 32. For the real hologram image 26, a plurality of holographic optical elements 16, 18, 20, 22 are grouped to form the single transmission hologram 54. In the hologram 54, there are a number of arc shaped segments 58, 60, 62, 64 which correspond to each of the respective holographic optical elements 16, 18, 20, 22. This can allow for some additional customization relating to the look of the hologram 54. For example, each segment 58, 60, 62, 64 can be a different color hologram 54, such that segment 58 is dark blue, 60 is light blue, 62 is light red, 64 is dark red to indicate various heating and cooling levels for a heating, ventilation, and air conditioning (HVAC) system 66. To achieve color, a collimating lens could be used. In embodiments wherein uncollimated light 48 comes directly from the display screen 32, achieving a multi-color hologram 54 may be difficult, and instead, the hologram may be a monochromatic gray color. It is also possible for the real holographic image 26 to be formed by a single holographic optical element instead of having the separate arc shaped segments 58, 60, 62, 64.

The real hologram image 26 has a circular shape 68, and more particularly, is structured as a ring 70 having an opening 72 where at least a portion of an image 74 on the display screen 32 is visible. The location of the real hologram image 26 depends at least to some extent on a position of a user, but it may be advantageous to angle or otherwise structure the holographic optical elements 16, 18, 20, 22 such that the hologram 54 is located more adjacent the uncovered portion of the display screen 32. This can allow for the display screen 32 to change depending on the input from the sensor 34. For example, an arc shaped path 76 (see e.g., FIG. 2) of a user's finger 36 can result in proportional adjustment to the HVAC system 66. A clockwise detected motion or arc shaped path 76 from the sensor 34 can proportionally change the temperature upwards, and a counterclockwise detected motion or path 76 can proportionally lower the temperature. The actual amount that the temperature is lowered can be reflected in the portion of the image 74, or at another location on the display screen 32, in some embodiments. This arrangement can be advantageous as it provides a visual cue to the user of the proportional adjustment resulting from the sensor 34 input. Additionally, a smaller arc-shaped path 76 can result in a smaller adjustment to the HVAC system 66 (e.g., a quarter of the circular shape 68 may result in a change of 2-5° F.), whereas a larger arc-shaped path 76 (e.g., two revolutions through the circular shape 68 may result in a 10-15° F. change), and the specific amount of proportional adjustment will depend on the desired specifications of the vehicle 12.

The other real hologram image 28 has a bar shape 78, and in the illustrated embodiment, has a gradient pattern 80 to help indicate a result in the proportional adjustment to a volume of the infotainment system 82. As with the real hologram image 26, it is possible for this hologram 54 to have a more simplistic structure when noncollimated light 48 is used from the backlighting display screen 32. In such an example, the real hologram image 26, 28 may have a simple shape and gray color. In this embodiment, there is another portion 84 of the display screen 32 that includes an indicator light 86 that changes based on input from the sensor 34 with respect to a linear path 88 of a user's finger 36 through the hologram 54 (see e.g., FIG. 3 for the linear path 88). In this embodiment, the movement of a user's finger 36 through the hologram 54 results in proportional adjustment to the volume of the infotainment system 82. For example, movement across the entirety of the bar shape 78 will result in a 100% change of the volume to the maximum or the minimum depending on the direction of the user's finger 36. Moving 25% of the distance through the bar shape 78 may result in a 25% change of the volume (e.g., if the volume goes from 0-100 and is currently set at the thirty level, the proportional adjustment will be either to 5 or to 55 depending on the direction of the user's finger 36). In this embodiment the linear path 88 of the user's finger 36 can be in an X-direction as shown, or in the Y-direction if the bar shape 78 is orthogonally oriented compared to the illustrations.

The real hologram images 26, 28 are set up in the style of a rotary switch and a slider or toggle style switch, respectively. It should be understood, however, that other switch styles and shapes are certainly possible. For example, it is possible for the display screen 32 to be much smaller such that it is not part of the main infotainment system 82, and a small, push-button style switch could be employed on the display panel 14. With such an embodiment, changes in the user's finger 36 through the hologram 54 in the Z-direction may be used to adjust the vehicle functionality. Additionally, other changes to the vehicle 12 can be accomplished via the holographic switches described herein, besides just changes to the HVAC system 66 and the infotainment system 82. To cite a few examples, switches for controls of wipers, lights, opening and closing of panels, etc., can be employed. Accordingly, the proportional adjustment to the vehicle functionality will vary depending on the system specifications, and such adjustment may be accomplished in a number of ways. For example, input from the sensor 34 and the adjustment may be controlled via a dedicated microcontroller or processor, another vehicle electronic device such as a body control module, or in another operable fashion.

With reference to the alternate configurations schematically illustrated in FIGS. 2 and 3, it is possible to locate the holographic optical elements 16, 18, 20, 22 on top of the cover lens 38 (FIG. 2), or beneath the cover lens (FIG. 3). As described, it may be beneficial to locate the surface relief pattern 46 as close to the passenger cabin 10 as possible, as in the FIG. 2 embodiment, to improve the appearance of the hologram 54. It is also possible to protect the holographic optical element 24, as shown in FIG. 3. This embodiment uses an optically clear adhesive (OCA) 40 to help embed the holographic optical element 24 between the sensor 34 and the cover lens 38. In this embodiment, it may be helpful to optimize the refractive indices of the OCA 40 and/or the cover lens 38 to improve the appearance of the hologram 54. Additionally, as described, other layers, films, etc. may be included depending on the desired implementation.

The sensor 34 is included within the display panel 14 to detect the presence, and in some embodiments, the location, of the user's finger 36. In an advantageous embodiment, the sensor 34 comprises light-transmissive hover touch capacitive sensor. Other sensors and configurations are possible, such as a series of discrete capacitive sensors, one or more one or more optical position sensors, etc. Pressure sensors could be used, but it is an advantage of the current arrangement that the user can interact with the hologram 54 itself without touching the cabin facing side 42 of the display panel 14. As shown, the size of the sensor 34 is larger than the size of the hologram 54, which can help provide more input information, as it can begin detecting the presence and/or location of the user's finger 36 before a command is initiated. The sensor 34 is “light-transmissive,” meaning that at least some light 48 from the display screen 32 is visible to a user in the interior of the passenger cabin 10. Light transmissive may include any non-opaque layer, such as one that is transparent, translucent, semi-transparent, semi-translucent, etc. In other embodiments, for example, a light transmissive layer may be made from an opaque material that has a plurality of perforations that facilitate at least some sufficient degree of light transmission.

In the illustrated embodiments, the sensor 34 provides input that can be used to control functionality of the vehicle 12. Advantageously, with a hover touch capacitive sensor 34, the change in position of the user's finger 36 through the real hologram image 26, 28 in an X-direction, in a Y-direction, in a Z-direction, or some combination thereof, results in a proportional adjustment to a vehicle function, as detailed herein. Moreover, the detection parameters can be adjusted in the Z-direction, depending on the height of the real hologram image 26, 28 from the cabin facing side 42 of the display panel 14, to detect when the user is interacting with the hologram 54. At this point, detection measurements in the X-direction, in the Y-direction, and/or in the Z-direction can be used as input signals to determine the proportional adjustment to the vehicle functionality.

The display screen 32 provides light 48 for creating the hologram 54. The display panel 14 and display screen 32 can have a much simpler construction than that illustrated, such as a small area on the door panel or the like, with the display screen 32 constituting an operable light source (e.g., fiber optic, fluorescent or incandescent bulb, light emitting diode (e.g., LED or OLED), etc.), the position of which may be at least partially dictated by the materials in the other layers of the panel 14. The display screen 32 may only provide a single light color, or it may provide multiple colors. In an advantageous embodiment, as illustrated, the display screen 32 has a portion 90 that displays images unassociated with the holographic switches, such that the real hologram images 26, 28 make up only a subset of the display panel 14. Other arrangements are certainly possible.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all the following: “A”; “B”; “C”; “A and B”; “A and C”; “B and C”; and “A, B, and C.”

1. A display panel for a vehicle, comprising:
a holographic optical element configured to create a real hologram image;
a sensor configured to detect a position of a user's finger with respect to the real hologram image;
a display screen configured to emit light through the holographic optical element, wherein the light from the display screen creates the real hologram image with the holographic optical element being located between the display screen and the real hologram image.

2. The display panel of claim 1, wherein a change of the position of the user's finger through the real hologram image in an X-direction, in a Y-direction, in a Z-direction, or in two or more of the X-direction, the Y-direction, and the Z-direction results in a proportional adjustment to a vehicle function.

3. The display panel of claim 2, wherein the real hologram image has a circular shape and an arced shape path of the user's finger in the X-direction and in the Y-direction results in the proportional adjustment to the vehicle function.

4. The display panel of claim 3, wherein the circular shape is a ring having an opening in a middle of the circular shape where at least a portion of an image on the display screen is visible.

5. The display panel of claim 2, wherein the real hologram image is a bar shape and the change of position of the user's finger in the X-direction or in the Y-direction results in the proportional adjustment.

6. The display panel of claim 2, wherein the vehicle function is a control of an HVAC system or a control of an infotainment system.

7. The display panel of claim 2, wherein an image on the display screen is configured to change to account for the proportional adjustment to the vehicle function.

8. The display panel of claim 1, wherein an image on the display screen is configured to change based on input from the sensor.

9. The display panel of claim 1, wherein the sensor is a light-transmissive hover touch capacitive sensor.

10. The display panel of claim 1, wherein the real holographic image is a transmission hologram.

11. The display panel of claim 10, wherein the holographic optical element is a computer generated holographic layer having a surface relief pattern.

12. The display panel of claim 1, wherein the holographic optical element is located on a cover lens adjacent an interior cabin of the vehicle.

13. The display panel of claim 1, wherein the holographic optical element is sealed with an optically clear adhesive layer between the display screen and a cover lens.

14. The display panel of claim 1, comprising a plurality of holographic optical elements, wherein each holographic optical element is configured to create a different segment of the real holographic image.

15. The display panel of claim 1, comprising a plurality of holographic optical elements, wherein a first holographic element of the plurality of holographic elements creates the real holographic image and a second holographic element of the plurality of holographic elements creates a separate, second real holographic image.
